(19) United States
(12) Patent Application Publication
(10) Pub. No.: US 2013/0204799 A1
(43) Pub. Date: Aug. 8, 2013

(54) METHOD FOR PATENT PURCHASE AND PURSUIT OF PATENT INFRINGEMENT VIA MOBILE DEVICE

(71) Applicant: Andrew Fallon CURTIS, Versailles, KY (US)

(72) Inventor: Andrew Fallon CURTIS, Versailles, KY (US)

(73) Assignee: FARK, INC., Versailles, KY (US)

(21) Appl. No.: 13/453,463

(22) Filed: Apr. 23, 2012

Related U.S. Application Data
(60) Provisional application No. 61/595,350, filed on Feb. 6, 2012.

(51) Int. Cl. G06Q 50/18

(52) U.S. Cl. 705/310

(57) ABSTRACT

A method for purchasing, acquiring, or licensing patents without having to invent or originate any patents, with the purchase, acquisition or licensing performed via mobile communication devices, followed by pursuing patent infringement claims against suspected infringers of purchased, acquired or licensed patents is disclosed. The invention includes in one embodiment (a) creation of an entity who does not typically file patents or have an inventive nature; (b) the purchase, acquisition or licensing of patents, preferably on the Internet, via a mobile device; (c) locating infringers of said patents; and (d) filing litigation regarding patent infringement of said purchased, acquired or licensed patents.

### RELATED APPLICATION DATA

This application claims priority to previously filed U.S. Provisional Patent Application No. 61/595,350, filed on Feb. 6, 2012, entitled “Business Method for Patent Purchase and Pursuit of Patent Infringement Via Mobile Device”, which is incorporated by reference herein in its entirety.

### FIELD OF THE INVENTION

A method for purchasing, acquiring, or licensing patents without having to invent or originate any patents, with the purchase, acquisition or licensing performed via mobile communication devices, followed by pursuing patent infringement claims against suspected infringers of purchased, acquired or licensed patents is disclosed. The invention includes in one embodiment (a) creation of an entity who does not typically file patents or have an inventive nature; (b) the purchase, acquisition or licensing of patents, preferably on the Internet, via a mobile device; (c) locating infringers of said patents; and (d) filing litigation regarding patent infringement of said purchased, acquired or licensed patents.

### BACKGROUND OF THE INVENTION

The method of a non-practicing entity (NPE) buying and/or acquiring patents from bankrupt or defunct companies and using those patents in an aggressive manner in lawsuits is known. In one embodiment an NPE is known as a person or company who buys and enforces patents against one or more alleged infringers in a manner considered by the target or observers as unduly aggressive or opportunistic, often with no intention to further develop, manufacture or market the patented invention. In another embodiment an NPE being a patent owner who does not manufacture or use the patented invention, but rather than abandoning the right to exclude, an NPE seeks to enforce its right through the negotiation of licenses and litigation either with accused infringers or with other NPE's.

Alternatively, the website www.patentfreedom.com defines an NPE simply as “any entity that earns or plans to earn the majority of its revenues from the licensing or enforcement of its intellectual property.” One unique aspect of NPE's being setup so to not sell products or services and therefore not infringing on the patent rights contained in other companies patent portfolios. This makes the NPE nearly invulnerable to any threats of counter-assertion, a common defense in patent lawsuits.

The prior art details the acquiring or licensing patents, locating infringers, and filing patent infringement lawsuits. This process is sometimes unfairly referred to by the media as the “patent troll process”. For purposes of this disclosure the terms NPE and patent troll process or patent troll being used interchangeably. The term, while controversial, is interchangeable in some instances with “NPE” and typically the NPE/Patent Troll has the following characteristics: they first purchase or license a patent, often from a bankrupt firm, and then litigate against another separate company by claiming that one of its products infringes on the purchased patent. They may also enforce patents against purported infringers without themselves intending to manufacture the patented product or supply the patented service. Typically these NPEs enforce patents but have no manufacturing or research base themselves as they focus their efforts solely on enforcing patent rights. Finally, in another embodiment the NPE may assert patent infringement claims against infringers who refuse to purchase a license or against a large industry in the hopes of reaching settlements or licensing agreements.

The costs for alleged infringers to defend these types of lawsuits are typically high. The average cost of defending against a patent infringement suit is typically $1 million or more prior to trial, and $2.5 million for a complete defense, even if successful. Because the costs and risks are high, alleged infringers may settle even non-meritorious suits they consider frivolous. The uncertainty and unpredictability of the outcome of jury trials also encourages settlement, thus lending to a favorable industry for those with the correct business model.

NPE's operate much like any other company that protects a patent portfolio. However, the NPE's focus is usually on obtaining additional money from existing uses of the patent, not from seeking out new applications for the technology disclosed. NPE's typically monitor the market for possible infringing technologies by watching popular products, news coverage and analysis. In one example, they may review published patent applications for signals that another company is developing potentially infringing technology, possibly unaware of their own patents. The NPE then develops a plan to proceed and may start by suing a vulnerable company with something to lose, or little money to defend itself, hoping that an early victory or settlement will establish a precedent to encourage other peer companies to acquiesce to the purchase of licenses. Alternately, they may attack an entire industry at once, hoping to overwhelm it.

In the past, this process only involved stationary devices with access to the Internet or in the alternative, it involved the bidding of patents at auction like those held by companies such as, for example, Ocean Tomo. This latter process involving multi-day events where purchasers bid upon and acquire unused or little known patents. Part of the downfall in the execution of this process involving the significant time lost, as most persons involved through employment by these entities or on contract with NPEs are time constrained and rarely stationary themselves. The tethering of one to a stationary device or a land-line being a significant impediment to the entities need to be constantly available. Add to this the current trend toward the use of mobile devices and one realizes the need for a new model to supplant the current model regarding the purchase, acquisition and enforcement of said patents. While currently it is possible to profitably run an NPE using traditional stationary devices, the actual researching of available patents, the purchase and acquisition of same, and locating potential patent infringers takes considerably less time (and therefore improves profitability) when done via mobile devices. In this sense, the prior art “patent troll process” or NPE is an antiquated business model, owing to the inconvenience of having to utilize stationary devices whenever they happen to be stationary, or its representatives who are taking advantage of a mobile marketplace.

Therefore there is a long felt need for the purchasing, acquiring, or licensing patents, the location of infringers and the filing of an infringement lawsuit done entirely via mobile devices.

### DETAILED DESCRIPTION

In one embodiment the invention discloses a method for pursuing infringers of patents comprising forming a business which includes a non-practicing entity, the non-practicing entity acquiring or licensing one or more patents, with the acquisition or licensing being done primarily via the transfer of information by communication devices over a wireless network where the non-practicing entity transmits and receives information by communication devices via the network and the non-practicing entity not being the original assignee or inventor of the one or more patents, locating one or more infringers of the one or more patents, and the non-practicing entity taking action against the one or more infringers.

In another embodiment the invention discloses a method for pursuing infringers of patents comprising forming a business which includes a non-practicing entity, the non-practicing entity acquiring or licensing one or more patents, with the acquiring or licensing being done primarily via the transfer of information by communication devices over a wireless network where the non-practicing entity transmits and receives information by communication devices via the network, the entity not being the original assignee or inventor of the one or more patents, with any searching being performed prior to acquiring or licensing being done via the transfer of information by communication devices over a wireless network where the non-practicing entity transmits and receives information by communication devices via the network to identify applicable patents and where the non-practicing entity does not practice the claims of the one or more patents or produce any tangible item as described in the claims of the one or more patents, locating one or more infringers of the one or more patents by searching via the transfer of information by communication devices over a wireless network where the non-practicing entity transmits and receives information via the network by communication devices for infringement of acquired or licensed patents, and the non-practicing entity taking action against the one or more infringers.

In yet another embodiment the invention discloses a method for pursuing infringers of patents comprising forming a business which includes a non-practicing entity, the non-practicing entity partnering with a partner entity which owns or licenses one or more patents, with the partnering being done primarily via the transfer of information by communication devices over a wireless network where the non-practicing entity transmits and receives information by communication devices via the network, the partner entity practicing the claims of the one or more patents or producing tangible items as described in the claims of the one or more patents and where the non-practicing entity does not practice the claims of the one or more patents or produce any tangible item as described in the claims of the one or more patents, locating one or more infringers of the one or more patents by searching via the transfer of information by communication devices over a wireless network where the non-practicing entity transmits and receives information via the network by communication devices for infringement of acquired or licensed patents, and the non-practicing entity taking action against the one or more infringers.

In still yet another embodiment the invention discloses a method for creating a non-practicing entity, having a business mailing address at which practically none of the employees perform functions related to the non-practicing entity, or having a business mailing address which forwards to a location where employees perform actions related to the non-practicing entity and the non-practicing entity not being the inventor nor original assignee of any patents, and not currently producing anything substantive nor practicing the invention via the patents it owns.

In an alternate embodiment, the method from above including the steps of searching the Internet via mobile device (or communication devices) to purchase, license or otherwise acquire patents, purchasing or licensing patents via mobile device on other online entities (for example eBay, Craigslist, Heritage Auctions, Ocena Tomo, etc) and receiving transfer or a license to use or litigate on behalf of said patents. A mobile device being defined as, but not limited to, cell phones, Blackberries, I-pads, laptops with internet accessibility, tablet devices with internet accessibility, smart phones, PDA's and the like. A mobile device also possessing the ability to transfer information over a wireless network where the device transmits and receives information via the network. A communication device being defined as the same.

In yet another alternative embodiment the business methods from above, further comprising the steps of locating potential infringers of acquired patents and searching the Internet via a mobile device for infringement or infringers of acquired patents.

In still yet another embodiment, the business methods as detailed above further comprising the steps of filing litigation against patent infringers via retained counsel, where the retained counsel duties include filing patent infringement lawsuits on behalf of the NPE and passing on some or all of the settlement claims to owners of the non-practicing entity.

### Example of Use

In one embodiment, a person or a corporation incorporates or forms a business, subsidiary or a new corporation. Typically this corporation or business is formed by a person or company who intend to buy and enforce patents against one or more alleged infringers in a manner considered by the target or observers as unduly aggressive or opportunistic, often with no real intention to further develop, manufacture or market the patented invention. In one embodiment this process being called the formation of a non-practicing entity (NPE). In another embodiment the business forming as a subsidiary one or more non-practicing entities (NPEs). During the formation or startup process the non-practicing entity may create a mail forwarding address or uses their own mail drop, and either retains or employs counsel. The mail forwarding address typically being used to obscure, disguise or shelter the identity or location of the non-practicing entity. The retaining or employment of counsel being necessary due to the nature of the business involving the acquisition of patent(s), possible licensing and eventually the filing of lawsuits against potential patent infringers.

The non-practicing entity, at some point, acquires a patent or a license to a patent via a mobile (or communication) device. This may or may not be done after a search is performed for relevant technologies or inventions of interest. This process may involve acquisition online through an online auction or other internet based means via a mobile device. In one embodiment the acquisition of the patent being either the purchase of the patent in a sale or alternatively obtaining a licensing agreement for a set period of time. In another embodiment, the acquisition of the patent may be as part of a group or larger block of patents.

In one embodiment the acquisition primarily via a mobile device meaning that at least half of the negotiation regarding the acquisition or licensing occur via a mobile device.

Once the required licensing or ownership interests are acquired, the non-practicing entity next locates infringers of this acquired or licensed patent. Alternatively, the location of infringers is done via a mobile device. In that scenario, the non-practicing entity uses the search capabilities of their mobile devices to locate potential infringers via simple search strategies on standard web search engines. In one embodiment the non-practicing entity searching the mobile devise using key phrases or key words from the patent to locate possible infringers. Once infringers are located, further searches can be done to determine the nature of the patent infringement and in some embodiments, the size of the infringing entity. One preferred embodiment targeting larger companies with fairly substantial cash reserves or means to fund possible settlements. Once the infringers are determined, and alternatively the relative size of the infringer established, the non-practicing entity files one or more patent infringement lawsuits against the accused infringer. The filing of the lawsuit being via normal legal filing procedures. In another embodiment the filing of a lawsuit being performed via a mobile device. In still yet another embodiment typical case filings being against multiple defendants in the same avenue or stream of commerce. For example, an non-practicing entity could file against all known hamburger restaurants infringing a hamburger assembly patent (potential infringers including McDonalds, Burger King, Wendy's, White Castle, Jack in the Box, Five Guys, etc.)

In one embodiment the searching primarily via a mobile device for infringement of acquired or licensed patents meaning that at least half of the searching regarding the potential infringement occur via a mobile device.

The level of infringing research prior to case file varying with the amount of risk the non-practicing entity is willing to take. In one embodiment, the actual infringing use being only moderately investigated (or in some cases not at all investigated) by the NPE. In one embodiment the research regarding potential infringers being performed via a mobile device. Typically, the higher the level of investigation by the non-practicing entity, the stronger the case that can be made by the non-practicing entity against the accused infringer.

After locating a possible accuser, one embodiment involving the NPE entering into immediate negotiations for a settlement on the possible infringement claims made against the accused infringer. This negotiation process sometimes starting even before the filing of a lawsuit. The non-practicing entity locates the infringer and begins corresponding with the infringer via electronic means, mobile means or standard mail, notifying the accuser of the possible infringement and the possibility of acquiring a license or an outright sale of the patent. If the early negotiations fail, the NPE typically filing a patent infringement lawsuit. Whenever possible, the non-practicing entity filing the lawsuit in a jurisdiction most favorable to the non-practicing entity.

In another embodiment, once a potential accuser of the patent is located, the non-practicing entity seeking a partner. This partner typically practicing the invention that is the subject of the patent at issue. The non-practicing entity can then work with the partner on a variety of assignments of the patent or licensing agreements. In this scenario, the lost profits of the newly acquired partner can be factored into any settlement or licensing negotiations. Returning to the burger example used before, an automatic hamburger assembly method being patented. The NPE acquiring this patent or the exclusive right to this patent via a mobile device. The NPE then searching for a partner, perhaps a small regional hamburger entity in Montana. The NPE agreeing to grant to the Montana hamburger entity the rights to the patent as the Montana hamburger entity practices the assembly method, or begins same after this agreement. Now the non-practicing entity has a partner who is losing profits to the other practicing this assembly method. This increases the amount of money and revenue which can be realized by the non-practicing entity. The partner, in this instance the Montana hamburger entity, having little to lose in the process and taking a percentage of the gains the non-practicing entity realized.

In one embodiment the partnering being done primarily via a mobile device meaning that at least half of the negotiation regarding the partnering occurring via a mobile device.

In another embodiment, the early negotiating step bypassed and the filing of a lawsuit being the infringers first notice of a possible infringement. Typically this tactic being employed by the NPEs when filing suit against multiple infringers. The NPE's actions in particular lawsuit will vary, however in one embodiment the strategy being geared toward early settlement. NPEs typically being very mobile and fast moving and trying to secure as large of a settlement in a short amount of time. In the previously mentioned burger example, the non-practicing entity could hope for a quick settlement by Wendy's so that they could extract the same from McDonald's and Burger King. The non-practicing entity hoping that the accused infringers do not wish to spend time and money fighting the burger assembly patent and therefore settling early. Typically, one infringer settling, setting the negotiation standard and others quickly following. This allows the accused infringers to return to the profitable burger wars instead of fighting the validity of burger assembly.

In one embodiment the filing of one or more additional lawsuits being done primarily via a mobile device meaning that the initial filing of litigation occur via a mobile device.

Once settlement negotiations reach mutual agreement (or in the alternative a favorable lawsuit ruling is obtained) the settlement money being collected, with some or all of the settlement distributed to the owners of the non-practicing entity based on the licensing agreements with the patent owners. For example, the non-practicing entity may only have rights to litigate on behalf of the patent owners via a licensing agreement. In these instances a percentage breakout is typically employed to portion the settlement obtained. In still yet another embodiment the non-practicing entity entering into an agreement with the patent owner to pursue litigation against possible infringers. In one embodiment, the negotiation and settlement of these amount again occurring via mobile devices.

In some instances, after any lawsuits are dismissed or settled, or in the alternative licensing agreements are reached, the non-practicing entity dissolving or disbanding as a corporation or entity. Such a practice commonly employed to avoid counter lawsuits against the non-practicing entity or to avoid traceability back to same. Alternatively the non-practicing entity creating a mail forwarding address so that the known address does not have employees (or at best a minimal number of employees), again protecting the non-practicing entity from any possible harm or harassment. In still yet another embodiment the non-practicing entity and/or its parent corporation creating multiple corporate layers around the business in a manner to limit the amount of liability created by the non-practicing entity on the multiple corporate layers.

1) A method for pursuing infringers of patents comprising:
a) forming a business which includes a non-practicing entity;
b) the non-practicing entity acquiring or licensing one or more patents, with the acquisition or licensing being done primarily via the transfer of information by communication devices over a wireless network where the non-practicing entity transmits and receives information by communication devices via the network and the non-practicing entity not being the original assignee or inventor of the one or more patents;
c) locating one or more infringers of the one or more patents; and
d) the non-practicing entity taking action against the one or more infringers.

2) The method of claim 1 including the step of creating a mailing address at which no employees of the non-practicing entity work or creating a mailing address of the non-practicing entity which forwards all correspondence to a second location where employees of the non-practicing entity actually work or reside.

3) The method of claim 1 where the non-practicing entity does not practice the claims of the one or more patents or produce any tangible item as described in the claims of the one or more patents acquired or licensed.

4) The method according to claim 1, further comprising the acquiring or licensing of the patents by searching via the transfer of information by communication devices over a wireless network where the non-practicing entity transmits and receives information by communication devices via the network to identify applicable patents.

5) A method according to claim 1, further comprising locating potential infringers of acquired patents by searching primarily via the transfer of information by communication devices over a wireless network where the non-practicing entity transmits and receives information by communication devices via the network to determine infringement of acquired or licensed patents.

6) A method according to claim 1, where the taking action involves the steps of:
a) retaining or employing counsel;
b) the counsel contacting the one or more infringers to alert the one or more infringers of the one or more patents; and
c) the counsel negotiating a licensing agreement on behalf of the non-practicing entity where the one or more infringers obtain a license to the one or more patents.

7) A method according to claim 1, where the taking action involves the steps of:
a) retaining or employing counsel;
b) the counsel filing a lawsuit on behalf of the non-practicing entity against the one or more infringers regarding the one or more patents; and
c) the counsel negotiating a licensing agreement on behalf of the non-practicing entity where the infringer obtains a license to the one or more patents.

8) A method according to claim 1, where the taking action involves the steps of:
a) retaining or employing counsel;
b) the counsel filing a lawsuit on behalf of the non-practicing entity against the one or more infringers regarding the one or more patents; and
c) the counsel settling the lawsuit in favor of the non-practicing entity followed by dismissing the one or more infringers from the lawsuit.

9) The method of claim 8 further comprising the step of dissolving the non-practicing entity after dismissing the one or more infringers from the lawsuit.

10) The method of claim 8 further comprising the filing of one or more additional lawsuits by the non-practicing entity and the non-practicing entity engaging in one or more settlement negotiations.

11) The method of claim 8 further comprising the filing of one or more additional lawsuits being done primarily via the transfer of information over a wireless network by communication devices where the non-practicing entity transmits and receives information by communication devices via the network.

12) The method of claim 1 where the non-practicing entity has less than 5 employees.

13) The method of claim 1 further comprising creating multiple corporate layers around the business in a manner to limit the amount of liability created by the non-practicing entity on the multiple corporate layers.

14) A method for pursuing infringers of patents comprising:
a) forming a business which includes a non-practicing entity;
b) the non-practicing entity acquiring or licensing one or more patents, with the acquiring or licensing being done primarily via the transfer of information by communication devices over a wireless network where the non-practicing entity transmits and receives information by communication devices via the network, the entity not being the original assignee or inventor of the one or more patents, with any searching being performed prior to acquiring or licensing being done via the transfer of information by communication devices over a wireless network where the non-practicing entity transmits and receives information by communication devices via the network to identify applicable patents and where the non-practicing entity does not practice the claims of the one or more patents or produce any tangible item as described in the claims of the one or more patents;
c) locating one or more infringers of the one or more patents by searching via the transfer of information by communication devices over a wireless network where the non-practicing entity transmits and receives information by communication devices via the network for infringement of acquired or licensed patents; and
d) the non-practicing entity taking action against the one or more infringers.

15) A method according to claim 14, where the taking action involves the steps of:
a) retaining or employing counsel;
b) the counsel contacting the one or more infringers to alert the one or more infringers of the one or more patents; and
c) the counsel negotiating a licensing agreement on behalf of the non-practicing entity where the one or more infringers obtain a license to the one or more patents.

16) A method according to claim 14, where the taking action involves the steps of:
a) retaining or employing counsel;
b) the counsel filing a lawsuit on behalf of the non-practicing entity against the one or more infringers regarding the acquired or licensed patents; and
c) the counsel negotiating a licensing agreement on behalf of the non-practicing entity where the infringer obtains a license to the one or more patents.

17) A method according to claim 14, where the taking action involves the steps of:
a) retaining or employing counsel;
b) the counsel filing a lawsuit on behalf of the non-practicing entity against the one or more infringers regarding the one or more patents; and
c) the counsel settling the lawsuit in favor of the non-practicing entity followed by dismissing the one or more infringers from the lawsuit.

18) The method of claim 17 further comprising the step of dissolving the non-practicing entity after dismissing the one or more infringers from the lawsuit.

19) The method of claim 17 further comprising the filing of one or more additional lawsuits by the non-practicing entity and the non-practicing entity engaging in one or more settlement negotiations.

20) The method of claim 17 further comprising the filing of one or more additional lawsuits being done primarily via the transfer of information by communication devices over a wireless network where the non-practicing entity transmits and receives information by communication devices via the network.

21) The method of claim 14 further comprising creating multiple corporate layers around the business in a manner to limit the amount of liability created by the non-practicing entity on the multiple corporate layers.

22) A method for pursuing infringers of patents comprising:
a) forming a business which includes a non-practicing entity;
b) the non-practicing entity partnering with a partner entity which owns or licenses one or more patents, with the partnering being done primarily via the transfer of information by communication devices over a wireless network where the non-practicing entity transmits and receives information by communication devices via the network, the partner entity practicing the claims of the one or more patents or producing tangible items as described in the claims of the one or more patents and where the non-practicing entity does not practice the claims of the one or more patents or produce any tangible item as described in the claims of the one or more patents;
c) locating one or more infringers of the one or more patents by searching via the transfer of information by communication devices over a wireless network where the non-practicing entity transmits and receives information by communication devices via the network for infringement of acquired or licensed patents; and
d) the non-practicing entity taking action against the one or more infringers.

23) A method according to claim 22, where the taking action involves the steps of:
a) retaining or employing counsel;
b) the counsel contacting the one or more infringers to alert the one or more infringers of the one or more patents;
c) the counsel negotiating a licensing agreement on behalf of the partner entity where the one or more infringers obtain a license to the one or more patents; and
d) the non-practicing entity and the partner entity sharing the license fees negotiated.

24) A method according to claim 22, where the taking action involves the steps of:
a) retaining or employing counsel;
b) the counsel filing a lawsuit on behalf of the partner entity against the one or more infringers regarding the one or more patents;
c) the counsel negotiating a licensing agreement on behalf of the partner entity where the one or more infringers obtain a license to the one or more patents; and
d) the non-practicing entity and the partner entity sharing the license fees negotiated.

25) A method according to claim 22, where the taking action involves the steps of:
a) retaining or employing counsel;
b) the counsel filing a lawsuit on behalf of the partner entity against the one or more infringers regarding the one or more patents;
c) the counsel settling the lawsuit in favor of the partner entity followed by dismissing the one or more infringers from the lawsuit; and
d) the non-practicing entity and the partner entity sharing the settlement negotiated.
